(19) United States
(12) Patent Application Publication
(10) Pub. No.: US 2023/0206564 A1
(43) Pub. Date: Jun. 29, 2023

(54) Video Processing Method, Electronic Device And Non-transitory Computer-Readable Storage Medium

(71) Applicant: Beijing Baidu Netcom Science Technology Co., Ltd., Beijing (CN)

(72) Inventors: Hao DONG, Beijing (CN); Peng LIU, Beijing (CN); Haowen LI, Beijing (CN)

(73) Assignee: Beijing Baidu Netcom Science Technology Co., Ltd, Beijing (CN)

(21) Appl. No.: 17/940,183

(22) Filed: Sep. 8, 2022

(30) Foreign Application Priority Data
Dec. 24, 2021 (CN) 202111604879.7

(51) Int. Cl. G06T 19/00; G10L 13/02

(52) U.S. Cl. CPC G06T 19/006; G10L 13/02

(57) ABSTRACT

Provided are a video processing method, an electronic device and a non-transitory computer-readable storage medium, relates to the field of data processing, and in particular to the field of video generation. The specific implementation solution is text content and a selection instruction are received, wherein the selection instruction is configured to indicate a model for generating a virtual object; the text content is converted into voice; a mixed deformation parameter set is generated according to the text content and the voice; and the model of the virtual object is rendered with the mixed deformation parameter set, so as to obtain a picture set of the virtual object, and generating, according to the picture set, a video that includes the virtual object for broadcasting the text content. By means of the present disclosure, it is possible to simplify a large number of complicated operations for video production.

### CROSS-REFERENCE TO RELATED APPLICATIONS

The present disclosure claims priority of Chinese Patent Application No. 202111604879.7, filed on Dec. 24, 2021, and named after “Video Processing Method and Apparatus, Electronic Device and Computer Storage Medium”. Contents of the Chinese Patent Application are hereby incorporated by reference in its entirety into the present disclosure.

### TECHNICAL FIELD

The present disclosure relates to the technical field of data processing, particularly relates to the field of video generation, and specifically relates to a video processing method, an electronic device and a non-transitory computer-readable storage medium.

### BACKGROUND OF THE INVENTION

In related arts, required propaganda and broadcast videos are generally produced manually by video editing works. Although video production can be realized, there are problems of low production efficiency and unsuitable for mass promotion.

### SUMMARY OF THE INVENTION

The present disclosure provides a video processing method, an electronic device and a non-transitory computer-readable storage medium.

According to one aspect of the present disclosure, a video processing method is provided, including: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating, according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating, according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

As at least one alternative embodiment, receiving the text content includes: collecting target voice; and performing text conversion on the target voice to obtain the text content.

According to another aspect of the present disclosure, an electronic device is provided, including: at least one processor; and a memory in communication connection with the at least one processor, wherein the memory stores instructions executable by the at least one processor, and the instructions are executed by the at least one processor, so that the at least one processor can execute the following actions: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

As at least one alternative embodiment, receiving the text content includes: collecting target voice; and performing text conversion on the target voice to obtain the text content.

According to yet another aspect of the present disclosure, non-transitory computer-readable storage medium storing computer instructions, wherein the computer instructions are used for enabling a computer to execute the following actions: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

It should be understood that, what is described in this section is not intended to identify critical or important features of the embodiments of the present disclosure, nor is it intended to limit the scope of the present disclosure. Other features of the present disclosure will become readily understood from the following description.

### BRIEF DESCRIPTION OF THE SEVERAL VIEWS OF THE DRAWINGS

Drawings are used for better understanding the present solution, but do not constitute a limitation to the present disclosure, wherein:

FIG. 1 is a flow diagram of a video processing method provided according to an embodiment of the present disclosure;

FIG. 2 is a schematic diagram of a video processing method provided according to an embodiment of the present disclosure;

FIG. 3a is a first schematic diagram of a video processing result of a video processing method provided according to an embodiment of the present disclosure;

FIG. 3b is a second schematic diagram of a video generation result of a video processing method provided according to an embodiment of the present disclosure;

FIG. 4 is a structural block diagram of a video processing apparatus provided according to an embodiment of the present disclosure; and

FIG. 5 is a schematic block diagram of an electronic device 500 provided according to an embodiment of the present disclosure.

### DETAILED DESCRIPTION OF THE INVENTION

Exemplary embodiments of the present disclosure will be described below with reference to the drawings, which include various details of the embodiments of the present disclosure to facilitate understanding and should be considered as exemplary only. Accordingly, those of ordinary skill in the art should be aware that, various changes and modifications can be made to the embodiments described herein without departing from the scope and spirit of the present disclosure. Also, for clarity and conciseness, descriptions of well-known functions and structures are omitted from the following description.

### DESCRIPTION OF REFERENCE SIGNS

A virtual anchor refers to an anchor who uses a virtual character to perform contribution activities on video websites, and is best known as a virtual YouTuber.

A voice-to-animation (Voice-to-Animation) technology is a technology that drives the virtual character to speak and feedback emotions and actions through voice.

Blendshape refers to a technology that realizes a combination of a variety of predefined shapes and any number by deforming a single grid.

In view of the disadvantages of high video production cost, low efficiency and unsuitable for mass promotion in related arts, embodiments of the present disclosure provide a video processing method, which can simplify a large number of complicated operations for video production, and solve the problems of high video production cost and low efficiency in the related arts.

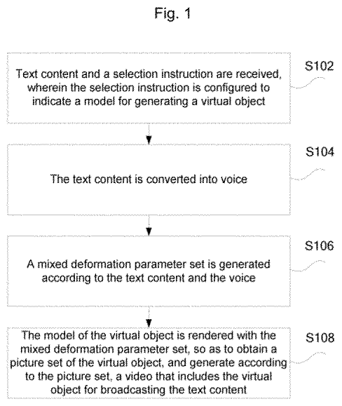

In an embodiment of the present disclosure, a video processing method is provided. FIG. 1 is a flow diagram of a video processing method provided according to an embodiment of the present disclosure. As shown in FIG. 1, the method includes:

Step S102, text content and a selection instruction are received, wherein the selection instruction is configured to indicate a model for generating a virtual object;

step S104, the text content is converted into voice;

step S106, a mixed deformation parameter set is generated according to the text content and the voice; and

step S108, the model of the virtual object is rendered with the mixed deformation parameter set, so as to obtain a picture set of the virtual object, and a video that includes the virtual object for broadcasting the text content is generate according to the picture set.

By means of the above method, it is possible to directly convert the text content into the voice, and generate the mixed deformation parameter set for rendering the model of the virtual object, that is, it is possible to directly generate, according to the received text content and the selection instruction, the video that includes the virtual object for broadcasting the text content, thereby greatly reducing steps requiring manual operations. Moreover, no complex operation is involved in the operation process, which greatly improves the production efficiency of broadcast videos, thereby reducing the production cost of the broadcast videos, and solving the problems of high video production cost and low efficiency in the related arts.

As an optional embodiment, when the mixed deformation parameter set is generated according to the text content and the voice, the mixed deformation parameter set can include various types. For example, the mixed deformation parameter set can include a first deformation parameter set and a second deformation parameter set. The first deformation parameter set is generated according to the text content, wherein the first deformation parameter set is configured to render a mouth shape of the virtual object; and the second deformation parameter set is generated according to the voice, wherein the second deformation parameter set is configured to render an expression of the virtual object. Generated mixed deformation parameters include various types. For example, deformation parameter sets for respectively rendering the mouth shape and the expression of the virtual object are generated, so that when a virtual character is driven, mouth muscles are naturally linked, mouth shape actions are accurate, and facial expressions are expressive and are realistic and natural when interacting with people.

As an optional embodiment, there can be various manners for generating according to the picture set, the video that includes the virtual object for broadcasting the text content. For example, the following manner may be employed, including: a first target background image is acquired; and the picture set is fused with the first target background image, so as to generate the video that includes the virtual object for broadcasting the text content. The first target background image is configured to provide a transparent channel for a subsequently generated video, that is, after the video is generated, the video can be directly synthesized, according to the video, with a video selected by the user, so as to obtain a video meeting requirements. Therefore, by means of the above manner, a video form in which a virtual person broadcasts can be generated, the user can conveniently incorporates his/her own video materials in the later stage, a room for secondary processing is reserved for the personalized requirements of the user, the flexibility and variability of video generation are improved, and the usage experience of the user is enhanced.

As an optional embodiment, there can be various manners for generating according to the picture set, the video that includes the virtual object for broadcasting the text content. For example, the following manner can be employed, including: a second target background image that is selected from a background gallery is acquired; and the picture set is fused with the second target background image, so as to generate the video that includes the virtual object for broadcasting the text content. By means of the above manner, a picture-in-picture video form can be generated, the second target background image selected from the background gallery can be displayed as a picture-in-picture area in a top left corner, the video required by the user can be directly and quickly generated, and can be directly used without secondary processing, thereby improving the usage experience of the user.

As an optional embodiment, there can be various manners for receiving the text content. For example, the following manner can be employed, including: target voice is collected; and text conversion is performed on the target voice to obtain the text content. By means of the above manner, the manner of acquiring the text content is not fixed. A text can be directly input, or context conversion is performed on the collected target voice. This method allows the user to flexibly select a suitable manner according to the existing text or voice materials, thereby simplifying preparation works of the user before producing the video, further reducing the cost of video production, improving the efficiency of video production, and enhancing the usage experience of the user.

According to the foregoing embodiments and optional embodiments, an optional embodiment is provided, which will be described below.

The user can manually make his/her own needed propaganda and broadcast videos by using various video editing software, but the production efficiency of manually editing the videos is low, such that it is inconvenient for mass promotion.

Based on the above problems, in an optional embodiment of the present disclosure, a video processing solution is provided. In this solution, a virtual anchor voice-to-animation (voice-to-animation) technology is employed, which can allow the user to input text or voice, and automatically generates, by means of VTA API, facial expression coefficients of a 3D virtual character corresponding to an audio stream, so as to complete the precise driving of the mouth shapes and facial expressions of the 3D virtual character. It is possible to help developers to quickly construct rich intelligent-driven applications of virtual characters, such as virtual hosts, virtual customer service personnel, virtual teachers, etc.

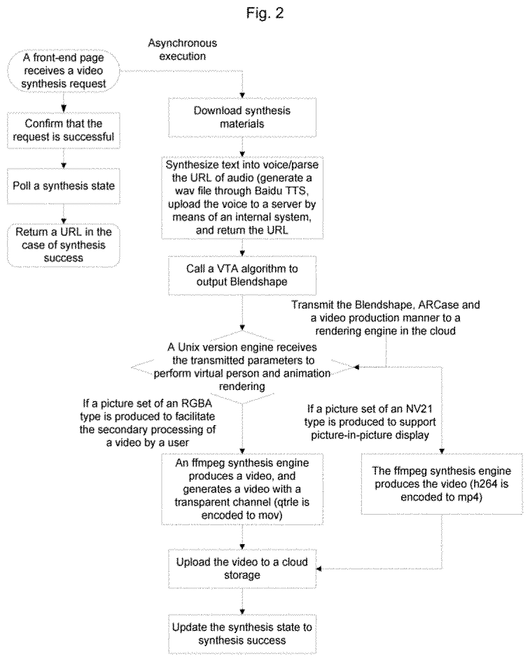

FIG. 2 is a schematic diagram of a video processing method provided according to an optional embodiment of the present disclosure. As shown in FIG. 2, the process includes the following processing:

(1) a video synthesis request is received by a front-end page, that the request is successful is confirmed, and polling a synthesis state is started until the video synthesis state is successful, and a uniform resource locator (Uniform Resource Locator, referred to as URL) is returned, wherein the above process and the following operations are executed asynchronously;

(2) synthesis materials is downloaded;

(3) text is synthesized into voice/parsing the URL of audio (for example, a way file (a sound file format) is generated through text to speech (Text to Speech, referred to as TTS), the voice is uploaded to a server by means of an internal system, and returning the URL)

(4) a voice-to-animation (Voice-to-Animation, referred to as VTA) algorithm is called to output Blendshape, and the Blendshape, ARCase and a video production manner is transmitted to a rendering engine in the cloud;

(5) the transmitted parameters is received by a Unix version engine to perform virtual person and animation rendering, wherein the text drives the mouth shape, the voice is synthesized by the text, timing sequence alignment of actions can be realized, and an animation Blendshape coefficient is generated, when the virtual character is driven, the mouth muscles can be naturally linked, and the voice drives the mouth shape; a mouth shape deformation coefficient is generated through the voice, and the virtual character can be driven to express precise mouth shapes and realistic facial expressions, such that the interaction with people is realistic and natural;

(6) if a picture set of an RGBA type is produced to facilitate the secondary processing of the video by the user, the video is produced by means of an ffmpeg synthesis engine, and a video is generated with a transparent channel (qtrle is encoded to mov), if a picture set of an NV21 type is produced to support picture-in-picture display, the video is produced by means of the ffmpeg synthesis engine (h264 is encoded to mp4);

(7) the produced video is uploaded to a cloud storage; and

(8) the synthesis state is updated to synthesis success.

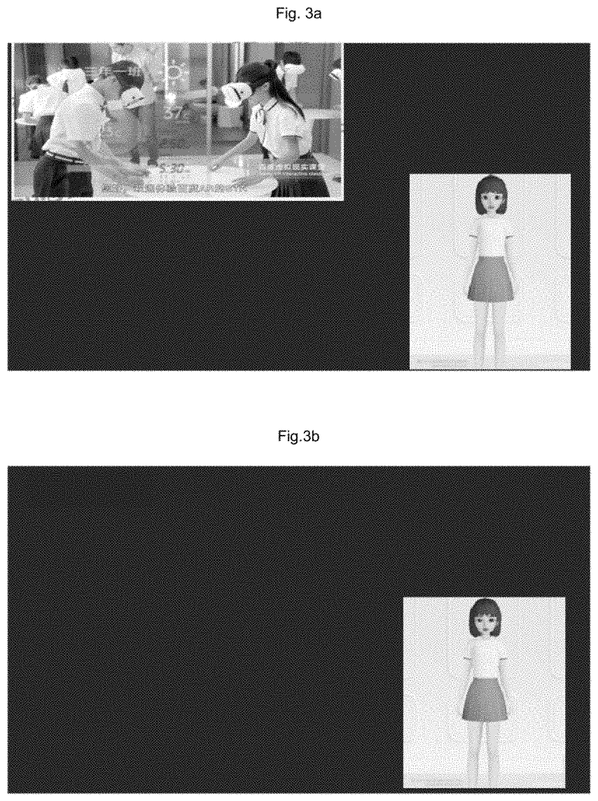

FIG. 3a is a first schematic diagram of a video generation result of a video processing method provided according to an embodiment of the present disclosure, wherein the figure shows a produced video in the form of picture-in-picture, and the user can find a segment of his/her own needed video from the gallery and display the same in a picture-in-picture area in a top left corner, and finally the video is integrated with model broadcast to generate a final release video during encoding. FIG. 3b is a second schematic diagram of a video generation result of a video processing method provided according to an embodiment of the present disclosure, wherein the figure shows a finally produced video form in which a virtual person broadcasts, with an alpha element in the background, which is convenient for the user to incorporate his/her own video materials subsequently, and the video is encoded with a video produced by the platform to form a final release material.

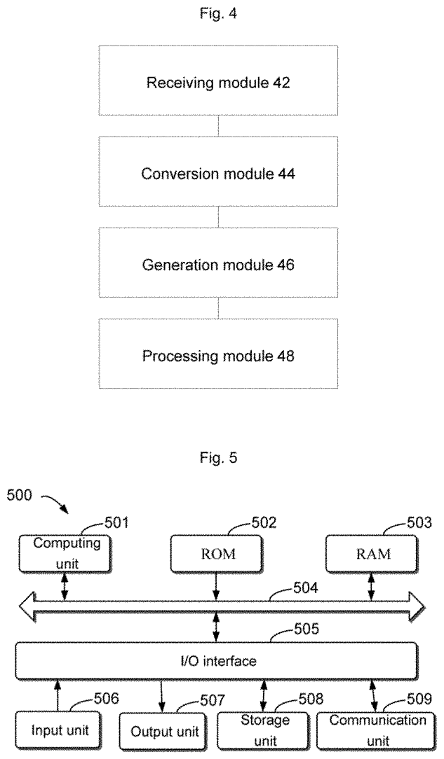

In an embodiment of the present disclosure, a video processing apparatus is further provided. FIG. 4 is a structural block diagram of a video processing apparatus provided according to an embodiment of the present disclosure. As shown in FIG. 4, the apparatus includes: a receiving module 42, a conversion module 44, a generation module 46 and a processing module 48, and the apparatus will be described below.

The receiving module 42 is configured to receive text content and a selection instruction, wherein the selection instruction is configured to indicate a model for generating a virtual object; the conversion module 44 is connected to the receiving module 42, and is configured to convert the text content into voice; the generation module 46 is connected to the conversion module 44, and is configured to generate a mixed deformation parameter set according to the text content and the voice; and the processing module is connected to the generation module 46, and is configured to render the model of the virtual object with the mixed deformation parameter set, so as to obtain a picture set of the virtual object, and generate according to the picture set, a video that includes the virtual object for broadcasting the text content.

As an optional embodiment, the generation module includes: a first generation unit, configured to generate a first deformation parameter set according to the text content, wherein the first deformation parameter set is configured to render a mouth shape of the virtual object; and a second generation unit, configured to generate a second deformation parameter set according to the voice, wherein the second deformation parameter set is configured to render an expression of the virtual object, and the mixed deformation parameter set includes the first deformation parameter set and the second deformation parameter set.

As an optional embodiment, the processing module includes: a first acquisition unit, configured to acquire a first target background image; and a third generation unit, configured to fuse the picture set with the first target background image, so as to generate the video that includes the virtual object for broadcasting the text content.

As an optional embodiment, the processing module includes: a second acquisition unit, configured to acquire a second target background image that is selected from a background gallery; and a fourth generation unit, configured to fuse the picture set with the second target background image, so as to generate the video that includes the virtual object for broadcasting the text content.

As an optional embodiment, the receiving module includes: a collection unit, configured to collect the target voice; and a conversion unit, configured to perform text conversion on the target voice to obtain the text content.

In the technical solutions of the present disclosure, the acquisition, storage, application and the like of personal information of the user involved are all in compliance with the provisions of relevant laws and regulations, and do not violate public order and good customs.

According to the embodiments of the present disclosure, the present disclosure further provides an electronic device, a non-transitory computer-readable readable storage medium and a computer program product.

FIG. 5 is a schematic block diagram of an electronic device 500 provided according to an embodiment of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile apparatuses, such as personal digital processors, cellular phones, smart phones, wearable devices, and other similar computing apparatuses. The components shown herein, their connections and relationships, and their functions are by way of example only, and are not intended to limit implementations of the present disclosure described and/or claimed herein.

As shown in FIG. 5, the electronic device 500 includes a computing unit 501, which can execute various appropriate actions and processing according to a computer program that is stored in a read only memory (ROM) 502 or a computer program that is loaded into a random access memory (RAM) 503 from a storage unit 508. In the RAM 503, various programs and data necessary for the operations of the electronic device 500 can also be stored. The computing unit 501, the ROM 502 and the RAM 503 are connected to each other by means of a bus 504. An input/output (I/O) interface 505 is also connected to the bus 504.

A plurality of components in the electronic device 500 are connected to the I/O interface 505, including: an input unit 506, such as a keyboard and a mouse; an output unit 507, such as various types of displays and loudspeakers; a storage unit 508, such as a magnetic disk and an optical disk; and a communication unit 509, such as a network card, a modem, and a wireless communication transceiver. The communication unit 509 allows the electronic device 500 to exchange information/data with other devices through a computer network such as the Internet and/or various telecommunication networks.

The computing unit 501 can be various general-purpose and/or special-purpose processing components with processing and computing capabilities. Some examples of computing unit 501 include, but are not limited to, a central processing unit (CPU), a graphics processing unit (GPU), various special-purpose artificial intelligence (AI) computing chips, various computing units that run machine learning model algorithms, a digital signal processor (DSP), and any suitable processor, controller, microcontroller, and so on. The computing unit 501 executes various methods and processing described above, such as the video processing method. For example, in some embodiments, the video processing method can be implemented as a computer software program, which is tangibly contained in a machine-readable medium, such as the storage unit 508. In some embodiments, part or all of computer programs can be loaded and/or installed on the electronic device 500 by means of the ROM 502 and/or the communication unit 509. When the computer programs are loaded into the RAM 503 and are executed by the computing unit 501, one or more steps of the video processing method described above can be executed. Alternatively, in other embodiments, the computing unit 501 can be configured to execute the video processing method in any other suitable manners (e.g., by means of firmware).

Various embodiments of the system and technology described above herein can be implemented in a digital electronic circuit system, an integrated circuit system, a field-programmable gate array (FPGA), an application-specific integrated circuit (ASIC), an application-specific standard product (ASSP), a system on chip (SOC), a load-programmable logic device (CPLD), computer hardware, firmware, software, and/or combinations thereof. These various embodiments can include: implementation in one or more computer programs, the one or more computer programs are executable and/or interpretable on a programmable system that includes at least one programmable processor, the programmable processor can be a special-purpose or general-purpose programmable processor, can receive data and instructions from a storage system, at least one input apparatus and at least one output apparatus, and transmit the data and instructions to the storage system, the at least one input apparatus and the at least one output apparatus.

Program codes for implementing the method of the present disclosure can be written by any combination of one or more programming languages. These program codes can be provided for a processor or controller of a general-purpose computer, a special-purpose computer or other programmable data processing apparatuses, such that when the program codes are executed by the processor or the controller, functions/operations specified in the flow diagrams and/or block diagrams are implemented. The program codes can be completely executed on a machine, partly on the machine, as a stand-alone software package, partly on the machine and partly on a remote machine, or completely on the remote machine or a server.

In the context of the present disclosure, the machine-readable medium can be a tangible medium, which can contain or store a program that can be used by an instruction execution system, apparatus or device, or is combined with the instruction execution system, apparatus or device for use. The machine-readable medium can be a machine-readable signal medium or a machine-readable storage medium. The computer-readable medium can be, but is not limited to, electronic, magnetic, optical, electromagnetic, infrared, or semiconductor systems, apparatuses or devices, or any suitable combination of the above content. More specific examples of the computer-readable storage medium include: an electrical connection based on one or more wires, a portable computer disk, a hard disk, a random access memory (RAM), a read only memory (ROM), an erasable programmable read only memory (EPROM or a flash memory), an optical fiber, a portable compact disc read-only memory (CD-ROM), an optical storage device, a magnetic storage device, or any suitable combination of the above content.

To provide interaction with the user, the systems and technologies described herein can be implemented on a computer, the computer has a display apparatus (e.g., a CRT (cathode ray tube) or an LCD (liquid crystal display) monitor) for displaying information to the user; and a keyboard and a pointing apparatus (e.g., a mouse or trackball), through which the user can provide an input for the computer. Other kinds of apparatuses can also be configured to provide interaction with the user. For example, the feedback provided for the user can be any form of sensory feedback (e.g., visual feedback, auditory feedback, or tactile feedback); and the input from the user can be received in any form (including acoustic input, voice input, or tactile input).

The systems and technologies described herein can be implemented in a computing system (e.g., serving as a data server) that includes a background component, or a computing system (e.g, an application server) that includes a middleware component, or a computing system (e.g, a user computer having a graphical user interface or web browser, through which the user can interact with the embodiments of the systems and technologies described herein), that includes a front-end component, or a computing system that includes any combination of the background component, the middleware component or the front-end component. The components of the system can be interconnected by any form or medium of digital data communication (e.g., a communication network). Examples of the communication network include: a local area network (LAN), a wide area network (WAN), and the Internet.

The computer system can include a client and a server. The client and the server are generally remote from each other and usually interact with each other by means of the communication network. The relationship between the client and the server is produced by computer programs that run on corresponding computers and have a client-server relationship with each other. The server can be a cloud server, a server of a distributed system, or a server combined with a blockchain.

As at least one alternative embodiment, the electronic device may include: at least one processor (such as the above computing unit 501); and a memory (such as the above the ROM 502 and the RAM 503) in communication connection with the at least one processor, wherein the memory stores instructions executable by the at least one processor, and the instructions are executed by the at least one processor, so that the at least one processor can execute the following actions: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

As at least one alternative embodiment, receiving the text content includes: collecting target voice; and performing text conversion on the target voice to obtain the text content.

In an embodiment of the present disclosure, a non-transitory computer-readable storage medium storing computer instructions is provided, wherein the computer instructions are used for enabling a computer to execute the following actions: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

In an embodiment of the present disclosure, a computer program product is provided, including a computer program, wherein when executed by a processor, the computer program executes the following actions: receiving text content and a selection instruction, wherein the selection instruction is configured to indicate a model for generating a virtual object; converting the text content into voice; generating a mixed deformation parameter set according to the text content and the voice; and rendering the model of the virtual object with the mixed deformation parameter set, so as to obtain a picture set of the virtual object, and generating according to the picture set, a video that includes the virtual object for broadcasting the text content.

As at least one alternative embodiment, generating the mixed deformation parameter set according to the text content and the voice includes: generating a first deformation parameter set according to the text content, wherein the first deformation parameter set is configured to render a mouth shape of the virtual object; and generating a second deformation parameter set according to the voice, wherein the second deformation parameter set is configured to render an expression of the virtual object, and the mixed deformation parameter set includes the first deformation parameter set and the second deformation parameter set.

As at least one alternative embodiment, generating according to the picture set, the video that includes the virtual object for broadcasting the text content includes: acquiring a first target background image; and fusing the picture set with the first target background image, so as to generate the video that includes the virtual object for broadcasting the text content.

As at least one alternative embodiment, generating according to the picture set, the video that includes the virtual object for broadcasting the text content includes: acquiring a second target background image that is selected from a background gallery; and fusing the picture set with the second target background image, so as to generate the video that includes the virtual object for broadcasting the text content.

It should be understood that steps can be reordered, added or deleted by using the various forms of flow shown above. For example, the steps described in the present disclosure can be executed in parallel, in sequence, or in different orders. As long as the desired results of the technical solutions disclosed in the present disclosure can be achieved, no limitation is imposed herein.

The above specific embodiments do not constitute a limitation on the protection scope of the present disclosure. It should be understood by those skilled in the art that, various modifications, combinations, sub-combinations and substitutions can be made depending on design requirements and other factors. Any modifications, equivalent replacements, improvements and the like, made within the spirit and principles of the present disclosure, should be included within the protection scope of the present disclosure.

What is claimed is:

1. A video processing method, comprising:
receiving text content and a selection instruction, wherein the selection instruction is configured to indicate a model for generating a virtual object;
converting the text content into voice;
generating a mixed deformation parameter set according to the text content and the voice; and
rendering the model of the virtual object with the mixed deformation parameter set, so as to obtain a picture set of the virtual object, and generating according to the picture set, a video that comprises the virtual object for broadcasting the text content.

2. The method according to claim 1, wherein generating the mixed deformation parameter set according to the text content and the voice comprises:
generating a first deformation parameter set according to the text content, wherein the first deformation parameter set is configured to render a mouth shape of the virtual object; and
generating a second deformation parameter set according to the voice, wherein the second deformation parameter set is configured to render an expression of the virtual object, and
the mixed deformation parameter set comprises the first deformation parameter set and the second deformation parameter set.

3. The method according to claim 1, wherein generating according to the picture set, the video that comprises the virtual object for broadcasting the text content comprises:
acquiring a first target background image; and
fusing the picture set with the first target background image, so as to generate the video that comprises the virtual object for broadcasting the text content.

4. The method according to claim 1, wherein generating according to the picture set, the video that comprises the virtual object for broadcasting the text content comprises:
acquiring a second target background image that is selected from a background gallery; and
fusing the picture set with the second target background image, so as to generate the video that comprises the virtual object for broadcasting the text content.

5. The method according to claim 1, wherein receiving the text content comprises:
collecting target voice; and
performing text conversion on the target voice to obtain the text content.

6. The method according to claim 2, wherein receiving the text content comprises:
collecting target voice; and
performing text conversion on the target voice to obtain the text content.

7. The method according to claim 3, wherein receiving the text content comprises:
collecting target voice; and
performing text conversion on the target voice to obtain the text content.

8. The method according to claim 4, wherein receiving the text content comprises:
collecting target voice; and
performing text conversion on the target voice to obtain the text content.

9. An electronic device, comprising:
at least one processor; and
a memory in communication connection with the at least one processor, wherein, the memory stores instructions executable by the at least one processor, and the instructions are executed by the at least one processor, so that the at least one processor can execute the following actions:
receiving text content and a selection instruction, wherein the selection instruction is configured to indicate a model for generating a virtual object;
converting the text content into voice;
generating a mixed deformation parameter set according to the text content and the voice; and
rendering the model of the virtual object with the mixed deformation parameter set, so as to obtain a picture set of the virtual object, and generating according to the picture set, a video that comprises the virtual object for broadcasting the text content.

10. The electronic device according to claim 9, wherein generating the mixed deformation parameter set according to the text content and the voice comprises:
generating a first deformation parameter set according to the text content, wherein the first deformation parameter set is configured to render a mouth shape of the virtual object; and
generating a second deformation parameter set according to the voice, wherein the second deformation parameter set is configured to render an expression of the virtual object, and
the mixed deformation parameter set comprises the first deformation parameter set and the second deformation parameter set.

11. The electronic device according to claim 9, wherein generating according to the picture set, the video that comprises the virtual object for broadcasting the text content comprises:
acquiring a first target background image; and
fusing the picture set with the first target background image, so as to generate the video that comprises the virtual object for broadcasting the text content.

12. The electronic device according to claim 9, wherein generating according to the picture set, the video that comprises the virtual object for broadcasting the text content comprises:
acquiring a second target background image that is selected from a background gallery; and
fusing the picture set with the second target background image, so as to generate the video that comprises the virtual object for broadcasting the text content.

13. The electronic device according to claim 9, wherein receiving the text content comprises:
collecting target voice; and
performing text conversion on the target voice to obtain the text content.

14. The electronic device according to claim 10, wherein receiving the text content comprises:
collecting target voice; and
performing text conversion on the target voice to obtain the text content.

15. The electronic device according to claim 11, wherein receiving the text content comprises:
collecting target voice; and
performing text conversion on the target voice to obtain the text content.

16. The electronic device according to claim 12, wherein receiving the text content comprises:
collecting target voice; and
performing text conversion on the target voice to obtain the text content.

17. A non-transitory computer-readable storage medium storing computer instructions, wherein the computer instructions are used for enabling a computer to execute the following actions:
receiving text content and a selection instruction, wherein the selection instruction is configured to indicate a model for generating a virtual object;
converting the text content into voice;
generating a mixed deformation parameter set according to the text content and the voice; and
rendering the model of the virtual object with the mixed deformation parameter set, so as to obtain a picture set of the virtual object, and generating according to the picture set, a video that comprises the virtual object for broadcasting the text content.

18. The non-transitory computer-readable storage medium according to claim 17, wherein generating the mixed deformation parameter set according to the text content and the voice comprises:
generating a first deformation parameter set according to the text content, wherein the first deformation parameter set is configured to render a mouth shape of the virtual object; and
generating a second deformation parameter set according to the voice, wherein the second deformation parameter set is configured to render an expression of the virtual object, and
the mixed deformation parameter set comprises the first deformation parameter set and the second deformation parameter set.

19. The non-transitory computer-readable storage medium according to claim 17, wherein generating according to the picture set, the video that comprises the virtual object for broadcasting the text content comprises:
acquiring a first target background image; and
fusing the picture set with the first target background image, so as to generate the video that comprises the virtual object for broadcasting the text content.

20. The non-transitory computer-readable storage medium according to claim 17, wherein generating according to the picture set, the video that comprises the virtual object for broadcasting the text content comprises:
acquiring a second target background image that is selected from a background gallery; and
fusing the picture set with the second target background image, so as to generate the video that comprises the virtual object for broadcasting the text content.
